(19) United States
(12) Patent Application Publication
(10) Pub. No.: US 2016/0345625 A1
(43) Pub. Date: Dec. 1, 2016

(54) ELECTRONIC CIGARETTE

(71) Applicant: Kimree Hi-Tech Inc., Tortola, Virgin Island (GB)

(72) Inventor: Qiuming LIU, Huizhou, Guangdong (CN)

(73) Assignee: Kimree Hi-Tech Inc., Tortola, Virgin Islands (GB)

(21) Appl. No.: 14/414,802

(22) PCT Filed: Feb. 20, 2014
(86) PCT No.: PCT/CN14/72311

§ 371 Date: Jan. 14, 2015

(30) Foreign Application Priority Data
Feb. 12, 2014 (CN) 201420063742.4

(51) Int. Cl. A24F 47/00; F16J 15/02

(52) U.S. Cl. CPC A24F 47/008; F16J 15/022

(57) ABSTRACT

An electronic cigarette is provided. The electronic cigarette includes a body of the electronic cigarette; the body of the electronic cigarette includes a suction end, a liquid storage adapted to store liquid, an atomizing assembly adapted to atomize the liquid, and a battery rod assembly adapted to supply power to the atomizing assembly; the liquid storage is arranged at an end of the body of the electronic cigarette away from the suction end. The electronic cigarette according to the disclosure may effectively avoid a suction of un-atomized liquid by a user.

The present application is the national phase of International Application No. PCT/CN2014/072311, titled “ELECTRONIC CIGARETTE”, filed on Feb. 20, 2014, which claims the priority to Chinese Patent Application No. 201420063742.4 titled “ELECTRONIC CIGARETTE”, filed with the Chinese State Intellectual Property Office on Feb. 12, 2014, which are incorporated by reference in herein in their entireties.

### FIELD

The present application relates to the technical field of electronic cigarette, and particularly to an electronic cigarette for avoiding a suction of un-atomized liquid by a user.

### BACKGROUND

A conventional structure of an electronic cigarette is shown in FIG. 1. As shown in FIG. 1, the conventional electronic cigarette includes an atomizing assembly 110 and a battery rod assembly 120 connecting to the atomizing assembly 110. An end of the atomizing assembly 110 away from the battery rod assembly 120 functions as a suction end 100, by which a user sucks out fumes. Further referring to FIG. 1, the atomizing assembly 110 is provided with a liquid storage 111 adapted to store liquid, a liquid storage cotton 112 arranged inside the liquid storage 111, and an electric heating wire assembly 113 adapted to atomize the liquid. A fume passage is formed inside the electronic cigarette, by which the user may suck out fumes atomized by the electric heating wire assembly 113.

In the electronic cigarette as shown in FIG. 1, since the liquid storage 111 is arranged close to the suction end 100 and is provided inside the fume passage, the liquid in the liquid storage 111 is prone to be leaked into the fume passage, resulting in a suction of un-atomized liquid by the user.

### SUMMARY

In view of this, an electronic cigarette for avoiding a suction of un-atomized liquid by a user is provided in the disclosure.

An electronic cigarette, includes:

a body of the electronic cigarette; wherein

the body of the electronic cigarette includes a suction end, a liquid storage adapted to store liquid, an atomizing assembly adapted to atomize the liquid, and a battery rod assembly adapted to supply power to the atomizing assembly;

the liquid storage is arranged at an end of the body of the electronic cigarette away from the suction end.

In the electronic cigarette, the atomizing assembly is disposed between the battery rod assembly and the liquid storage, the suction end is disposed outside one end of the battery rod assembly, or the suction end is disposed at the middle portion of the battery rod assembly, or the suction end is disposed on a portion of the battery rod assembly away from the atomizing assembly.

In the electronic cigarette, the liquid storage is detachably connected with the atomizing assembly;

and/or, the atomizing assembly is detachably connected with the battery rod assembly.

In the electronic cigarette, the atomizing assembly and the battery rod assembly are coaxially arranged.

In the electronic cigarette, the atomizing assembly includes:

an electric hearing wire assembly adapted to atomize the liquid; and

a liquid conveyer adapted to convey the liquid stored in the liquid storage to the electric heating wire assembly for atomization.

In the electronic cigarette, the atomizing assembly further includes:

an atomizer holder; wherein

a first thread sleeve adapted to be detachably connected with the battery rod assembly is arranged at a top of the atomizing holder;

a atomizer electrode is fixedly arranged inside the first thread sleeve and is electrically connected with the electric heating wire assembly;

an insulating ring is arranged between the first thread sleeve and the atomizer electrode; and

an atomizing sleeve is arranged on the atomizer holder, and the liquid conveyer is arranged inside the atomizing sleeve.

In the electronic cigarette, a fume passage adapted to communicate the suction end with an air inlet is arranged inside the battery rod assembly;

the air inlet is arranged on between junction surface of the atomizing assembly and the liquid storage;

or,

the air inlet is arranged on an outer wall of the atomizing assembly.

In the electronic cigarette, the battery rod assembly includes:

a battery sleeve;

a battery accommodated in the battery sleeve;

a battery holder adapted to fix the battery, wherein the battery holder is arranged in the battery sleeve;

a battery electrode arranged at one end of the battery holder and connected with the battery and the atomizer electrode separately; and

a second thread sleeve matching with the first thread sleeve to achieve a detachable connection between the battery rod assembly and the atomizing assembly.

In the electronic cigarette,

a sealing ring adapted to seal the liquid storage is arranged at the joint of the atomizer holder and the liquid storage.

In the electronic cigarette,

an annular sealing plug with a through hole is arranged for matching with a mouth of the liquid storage in a sealed manner; and

a piercable membrane adapted to seal the liquid storage is arranged in the through hole of the annular sealing plug.

In the electronic cigarette, the battery rod assembly further includes:

an airflow sensor adapted to generate a pulse signal; and

a microcontroller adapted to generate a control signal according to the pulse signal, wherein the microcontroller is connected with the airflow sensor and the battery; and

the microcontroller is connected with the electric heating wire assembly, such that the electric heating wire assembly atomizes the liquid according to the control signal.

In the electronic cigarette, the battery rod assembly further includes:

a button adapted to receive a user operation instruction, wherein the button is arranged on the battery sleeve; and

a light touch switch adapted to generate a control signal according to the operation instructions, wherein the light touch switch is connected with the button; and

the light touch switch is connected with the electric heating wire assembly, such that the electric heating wire assembly can atomize the liquid according to the control signal.

In the electronic cigarette, a suction nozzle as the suction end is detachably connected with the battery sleeve.

In the electronic cigarette, wherein the liquid storage is a transparent container.

In the electronic cigarette, wherein the liquid storage is a glass bottle.

The electronic cigarette according to the disclosure includes: a body of the electronic cigarette; wherein the body of the electronic cigarette includes a suction end, a liquid storage adapted to store liquid, an atomizing assembly adapted to atomize the liquid, and a battery rod assembly adapted to supply power to the atomizing assembly; the liquid storage is arranged at one end of the body of the electronic cigarette away from the suction end. The liquid storage of the electronic cigarette in the disclosure is arranged at an end of the body of the electronic cigarette away from the suction end, i.e. the position of the liquid storage is away from the suction end. The electronic cigarette provided in the disclosure may effectively avoid a suction of un-atomized liquid by a user.

### BRIEF DESCRIPTION OF THE DRAWINGS

In order to more clearly illustrate the embodiments in the disclosure or the technical solution in common technology, drawings referred to describe the embodiments or common technology will be briefly described hereinafter. Apparently, the drawings in the following description are only several embodiments of the present application, and for those skilled in the art, other drawings may be obtained based on these drawings without any creative work.

FIG. 1 is a sectional structural view of a conventional electronic cigarette;

FIG. 2 is a overall structural view of an electronic cigarette according to a preferable embodiment of the disclosure;

FIG. 3 is a sectional structural view of an atomizing assembly of an electronic cigarette according to a preferable embodiment of the disclosure;

FIG. 4 is a sectional structural view of a liquid storage of an electronic cigarette according to a preferable embodiment of the disclosure;

FIG. 5 is a sectional structural view of a battery rod assembly of an electronic cigarette according to a preferable embodiment of the disclosure;

FIG. 6 is a sectional structural view of an electronic cigarette according to another preferable embodiment of the disclosure;

FIG. 7 is a sectional structural view of an electronic cigarette according to another preferable embodiment of the disclosure;

FIG. 8 is another sectional structural view of a battery rod assembly of an electronic cigarette according to the disclosure;

FIG. 9 is a sectional structural view of an electronic cigarette according to another preferable embodiment of the disclosure;

FIG. 10 is a sectional structural view of an electronic cigarette according to another preferable embodiment of the disclosure; and

FIG. 11 is a sectional structural view of an electronic cigarette according to another preferable embodiment of the disclosure.

### DETAILED DESCRIPTION OF EMBODIMENTS

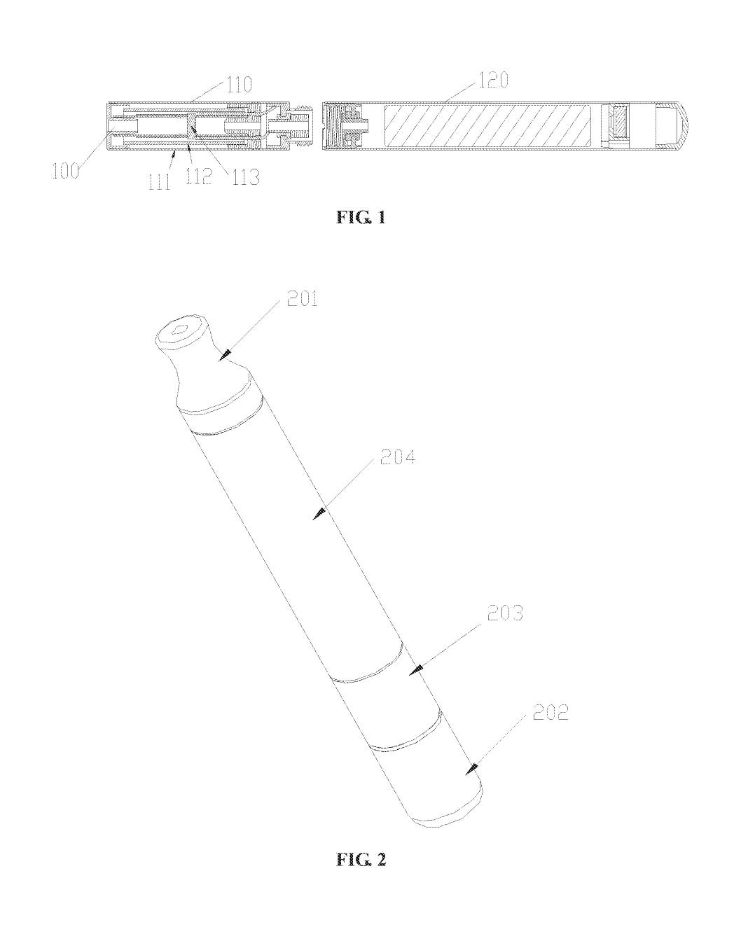

The disclosure provides an electronic cigarette having a structure shown in FIG. 2.

As shown in FIG. 2, the electronic cigarette includes the following elements.

The electronic cigarette includes a body of the electronic cigarette, where the body of the electronic cigarette is provided with a suction end 201, by which the user may suck out fumes.

A liquid storage 202 is adapted to store liquid, i.e. the liquid which can be atomized is stored in the liquid storage 202.

An atomizing assembly 203 is adapted to atomize the liquid, i.e. the liquid stored in the liquid storage 202 can be atomized by the atomizing assembly 203.

A fume passage (not shown in FIG. 2) for the circulation of the atomized liquid is formed in the body of the electronic cigarette, so that the user can suck the liquid flowing through the fume passage via the suction end 201.

The body of the electronic cigarette further includes a battery rod assembly 204 adapted to supply power to the atomizing assembly 203.

As shown in FIG. 2, the liquid storage 202 is arranged on the body of the electronic cigarette at an end away from the suction end 201. The advantage of this arrangement lies in that, the liquid storage 202 is arranged away from the suction end 201, the fume passage inside the body of the electronic cigarette does not pass through the liquid storage 202, such that the un-atomized liquid in the liquid storage 202 may not be leaked into the fume passage, and the user may not suck the un-atomized liquid, which effectively avoids the leakage of the liquid. Also, the fume passage, which does not pass through the liquid storage 202, may also avoid a condensation of the fumes in the fume passage, and therefore effectively avoids a blockage of the fume passage due to the condensed liquid.

The specific structure of the electronic cigarette provided in the embodiment is further illustrated in detailed in conjunction with FIG. 2. The atomizing assembly 203 is disposed between the battery rod assembly 204 and the liquid storage 202, and the suction end 201 is disposed outside one end of the battery rod assembly 204, or the suction end 201 is disposed at the middle portion of the battery rod assembly 204, or the suction end 201 is disposed on a portion of the battery rod assembly 204 away from the atomizing assembly 203.

The suction end 201 disposed outside one end of the battery rod assembly 204 may be arranged coaxially with the battery rod assembly 204. With such an arrangement, the appearance of the electronic cigarette may visually imitate a real cigarette, and the whole fume passage is substantially straight, therefore effectively reducing liquid accumulation.

Alternatively, the suction end 201 may be disposed at the middle portion of the battery rod assembly 204, or the suction end 201 may be disposed at a portion of the battery rod assembly 204 away from the atomizing assembly 203.

In the disclosure, the position of the suction end 201 is not limited.

In this embodiment, in order to allow the overall structure of the electronic cigarette imitate a real cigarette, to be in conformity with the habit of the user and reduce liquid accumulation, the atomizing assembly 203 and the battery rod assembly 204 are coaxially arranged.

The specific arrangement will not be limited in this embodiment. For example, the battery rod assembly 204, the atomizing assembly 203 and the liquid storage 202 sequentially connected may be arranged to be staggered such that the electronic cigarette may have an irregular overall appearance in any shape.

The atomizing assembly 203 and the battery rod assembly 204 may also be non-coaxially arranged, i.e. the liquid storage 202 and the atomizing assembly 203 are juxtaposed, the liquid storage 202 and the atomizing assembly 203 are respectively connected with the battery rod assembly 204, thus the overall structure of the electronic cigarette is in a T-shape.

In this embodiment, an appearance of the electronic cigarette is not limited, as long as the liquid storage 202 is arranged at a portion away from the suction end 201.

In this embodiment, the atomizing assembly 203 is disposed between the battery rod assembly 204 and the liquid storage 202, i.e. the atomizing assembly 203 is away from the suction end 201, and when the user sucks out fumes with the electronic cigarette provided in this embodiment, the atomizing assembly 203 is away from the mouth of the user, thus the user will not be burnt by heat which is generated in the atomizing assembly 203 for atomizing the liquid, effectively improving the safety of the usage of the electronic cigarette. Also, during smoking, the user generally grips the battery rod assembly 204, rather than griping the hot atomizing assembly 203 as in the existing technology, such that when the user smokes with the electronic cigarette according to this embodiment, the hand of the user will not be burnt, thereby effectively imitating the temperature of real cigarette, and improving user experience during smoke.

Preferably, the liquid storage 202 is detachably connected with the atomizing assembly 203, and/or, the atomizing assembly 203 is detachably connected with the battery rod assembly 204.

The detachable connection between the liquid storage 202 and the atomizing assembly 203, and/or, the detachable connection between the atomizing assembly 203 and the battery rod assembly 204 may be a threaded connection or a clamped connection. The manner of connection is not limited in this embodiment, as long as the liquid storage 202 is detachably connected with the atomizing assembly 203, and/or, the atomizing assembly 203 is detachably connected with the battery rod assembly 204.

The advantage of the detachable connection lies in that, the user may replace the atomizing assembly 203 or disassemble the liquid storage 202 whenever necessary, thus the user can conveniently add the liquid to the liquid storage 202 or replace the liquid storage 202. The connection between the liquid storage 202 and the atomizing assembly 203, and/or, the connection between the atomizing assembly 203 and the battery rod assembly 204 may be a non-detachable connection, and the disclosure is not limited in this aspect.

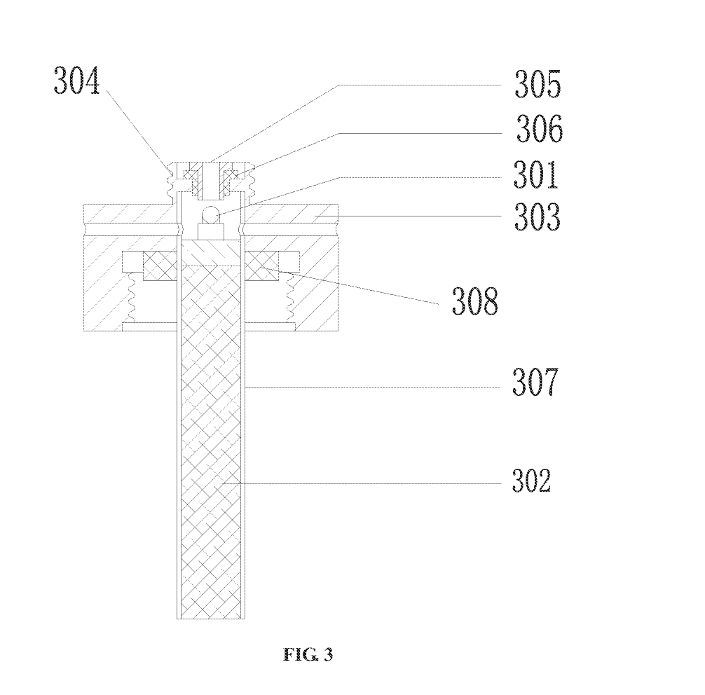

The atomizing assembly of the electronic cigarette is illustrated in detail in conjunction with an embodiment shown in FIG. 3 as follows.

As shown in FIG. 3, the atomizing assembly 203 includes:

an atomizer holder 303.

A first thread sleeve 304 adapted to be detachably connected with the battery rod assembly 204 is arranged at a top of the atomizing holder 303.

In this embodiment, the case that the atomizing assembly 203 and the battery rod assembly 204 are in thread connection is taken as an example to illustrate, that is, in the case that the atomizing assembly 203 is connected with the battery rod assembly 204 through threads, the first thread sleeve 304 is arranged at the top of the atomizing holder 303. If other detachable connection structure is taken, other connection structure, for example an elastic clamping strip for a clamped connection, etc., may be arranged at the top of the atomizing holder 303. In this embodiment, the thread sleeve is only taken as an example to illustrate, and the disclosure is not so limited.

A atomizer electrode 305 is fixedly arranged inside the first thread sleeve 304.

An insulating ring 306 is arranged between the first thread sleeve 304 and the atomizer electrode 305.

An electric heating wire assembly 301 is electrically connected with the atomizer electrode 305, and the electric heating wire assembly 301 can atomize the liquid.

A liquid conveyer 302 is adapted to convey the liquid stored in the liquid storage 202 to the electric heating wire assembly 301 for atomization, the liquid conveyer 302 may be implemented into for example liquid storage cotton, or liquid conveying fibers, which will not be limited herein.

An atomizing sleeve 307 is arranged on the atomizer holder 303, and the liquid conveyer 302 is arranged inside the atomizing sleeve 307.

The atomizing sleeve 307 inserts into the liquid storage 202, and at least one liquid conveying hole is arranged on a circumferential wall of the atomizing sleeve 307, through which the liquid in the liquid storage 202 may be successfully conveyed to the liquid conveyer 302.

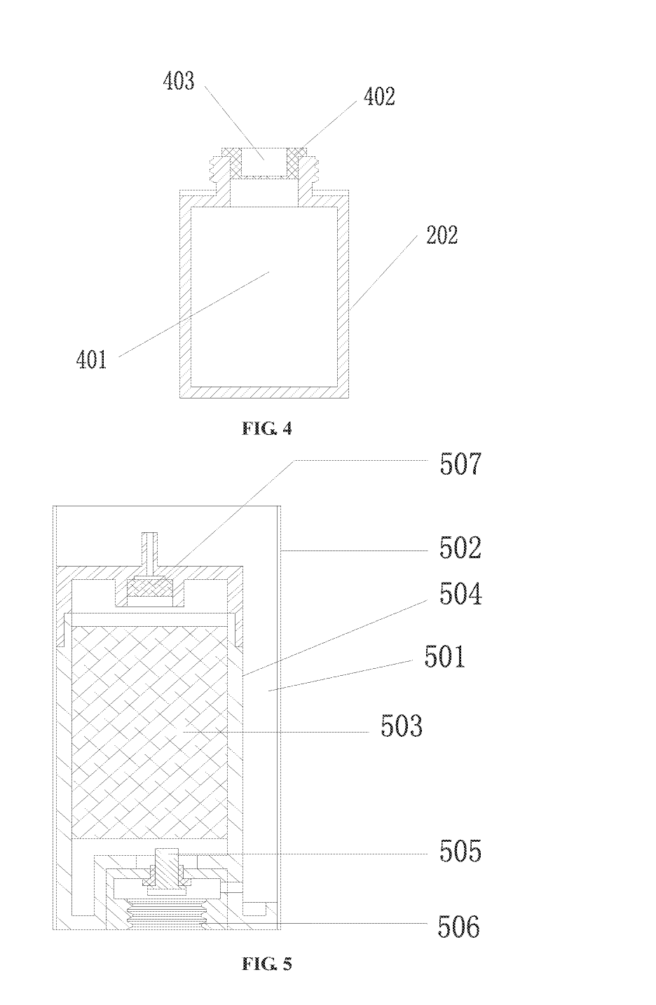

The liquid storage provided in the disclosure is illustrated in detail in conjunction with an embodiment shown in FIG. 4 as follows.

As shown in FIG. 4, a sealed cavity 401 is arranged inside the liquid storage 202, and the liquid is stored in the sealed cavity 401 in a sealed manner.

In order that the user can know the amount of the residual liquid inside the liquid storage 202, the liquid storage 202 is a transparent container, the user may, whenever necessary, know the amount of residual liquid in the electronic cigarette through the transparent liquid storage 202, which facilitates the timely replacement of the liquid storage 202 by the user.

Preferably, the liquid storage 202 is a glass bottle. The nature of glass material is relatively stable, which can avoid the influence of the scent of the liquid due to chemical reactions or the like.

More preferably, an outer circumferential wall of the liquid storage 202 made of glass is provided with scales, thus enabling the user to estimate the time span before the depletion of the remained liquid and facilitate the using by the user.

Preferably, a protective cartridge (not shown in FIG. 4) is sleeved on the liquid storage 202, so as to prevent the liquid storage 202 of glass material from being broken due to falling off.

More preferably, the protective cartridge is provided with a liquid observing window, for the user to observe the liquid.

In order to imitate a cigarette, the length of the electronic cigarette is generally equivalent to the length of a cigarette, and in order to reduce the frequency of being charged so as to extend the service life of the battery rod assembly 204, the length of the battery rod assembly 204 may at least take up over a half of the length of the entire electronic cigarette. When the user sucks out fumes by the electronic cigarette in this embodiment, the user may naturally grip the electronic cigarette at upper-middle portion of the electronic cigarette close to the suction end 201. Since the liquid storage 202 in this embodiment is arranged at an end away from the suction end 201, it is avoided that the liquid storage 202 is subjected to a griping force applied by the user, the amount of the liquid output from the liquid storage 202 to the atomizing assembly 203 is more uniform, effectively ensuring the stability of the fumes and improving the user experience. It is avoided that the liquid is output unevenly due to the varying force applied at the end of the atomizing assembly, which may result in uneven amount of fumes.

In order to effectively ensure a good sealing of the liquid storage 202 and effectively avoiding the leakage of the liquid, there are two arrangements in this embodiment:

Referring to FIG. 3, in the first arrangement, in order to ensure a good sealing of the liquid storage 202 connected with the atomizing assembly 203 and to ensure the liquid inside the liquid storage 202 not to leak, a sealing ring 308 adapted to seal the liquid storage 202 is arranged at the joint between the atomizer holder 303 and the liquid storage 202.

The sealing of the liquid storage 202 can be effectively ensured by the sealing ring 308 arranged on the atomizer holder 303.

Referring to FIG. 4, in the second arrangement, an annular sealing plug 402 with a through hole is arranged for matching with the mouth of the liquid storage 202 in a sealed manner.

A piercable membrane 403 for sealing the liquid storage 202 is arranged in the through hole of the annular sealing plug 402.

When the atomizing sleeve 307 inserts into the sealed cavity 401 of the liquid storage 202, the atomizing sleeve 307 passes through the piercable membrane 403, through which the liquid storage 202 inserted by the atomizing sleeve 307 still has good sealing, effectively avoiding the leakage of the liquid.

In this embodiment, the liquid storage 202 is provided with the annular sealing plug 402 with the piercable membrane 403, the liquid storage 202 has good sealing, effectively avoiding the leakage of the liquid, extending the service time of the electronic cigarette and ensuring service life of the electronic cigarette.

The battery rod assembly of the electronic cigarette provided in the disclosure is illustrated in detail in conjunction with an embodiment shown in FIG. 5 as follows.

As shown in FIG. 5, the battery rod assembly includes:

a battery sleeve 502.

The suction end 201 shown in FIG. 2 may be integrated with the battery sleeve 502 by extending from one end of the battery sleeve 502, or a nozzle as the suction end 201 is detachably connected with the battery sleeve 502, the specific arrangement is not limited in this embodiment.

In this embodiment, the nozzle as the suction end 201 is detachably connected, thus the user can replace or wash the nozzle whenever necessary, thus avoiding to suck the liquid in the nozzle and facilitating the clean of the liquid in the battery rod assembly.

A battery 503 is accommodated in the battery sleeve 502.

A battery holder 504 adapted to fix the battery 503 is arranged inside the battery sleeve 502.

A battery electrode 505 is arranged at one end of the battery holder 504, and is connected with the battery 503 and the atomizer electrode 305 (not shown in FIG. 3).

A second thread sleeve 506 is arranged for matching with the first thread sleeve 304 (shown in FIG. 3), and the second thread sleeve 506 is adapted to enable the detachable connection between the battery rod assembly 204 and the atomizing assembly 203.

Although the illustration is made by taking the case that the battery rod assembly 204 and the atomizing assembly 203 are in thread connection through the second thread sleeve 506 as an example in this embodiment, it should be noted that the battery rod assembly 204 and the atomizing assembly 203 may also be connected through other detachable connection, which will not be limited herein.

Further, as shown in FIG. 5, a fume passage 501 adapted to communicate the suction end 201 with an air inlet is arranged inside the battery rod assembly 204.

Preferably, the fume passage 501 is sealed inside the battery rod assembly 204, that is, the fume passage 501 is isolated from other electron components inside the battery rod assembly 204.

There are two arrangements for the air inlet communicating with the fume passage 501. It should be noted that the following arrangements for the air inlet are only exemplary but not limiting, as long as the air inlet in the body of the electronic cigarette is communicated with the suction end 201 by the fume passage 501.

In the first arrangement, the air inlet is arranged on a junction surface between the atomizing assembly 203 and the liquid storage 202; for example, a bump or a rib is arranged on a junction surface between the atomizing assembly 203 and the liquid storage 202, an air inlet for the access of air can be formed between the atomizing assembly 203 and the liquid storage 202 which are thread-connected with each other, thus the air flows into the fume passage 501 through the air inlet.

It should be noted that the arrangement of the air inlet is not limited, as long as an air inlet for access of air can be formed between the atomizing assembly 203 and the liquid storage 202.

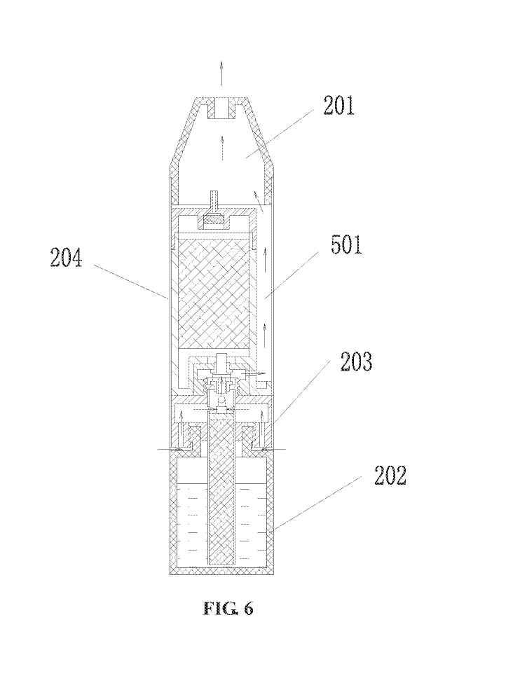

The suction end 201 is communicated with the air inlet by the fume passage 501, as shown in FIG. 6. FIG. 6 is a sectional structural view of an electronic cigarette in which the air inlet is arranged on a junction surface between the atomizing assembly 203 and the liquid storage 202.

As shown in FIG. 6, the air inlet, which is arranged on a junction surface between the atomizing assembly 203 and the liquid storage 202, is communicated with the suction end 201 by the fume passage 501.

In this embodiment, airflow direction inside the electronic cigarette is presented by the arrow as shown in FIG. 6, the airflow direction does not pass through the liquid storage 202, so that the fumes atomized by the atomizing assembly 203 flow to the suction end 201 without passing through the liquid storage 202, and the fumes do not condense due to the suction in the liquid storage 202 and do not block the fume passage 501.

In the second arrangement of the air inlet, the air inlet may be arranged on an outer wall of the atomizing assembly 203, and the specific position and number of the inlet(s) are not limited.

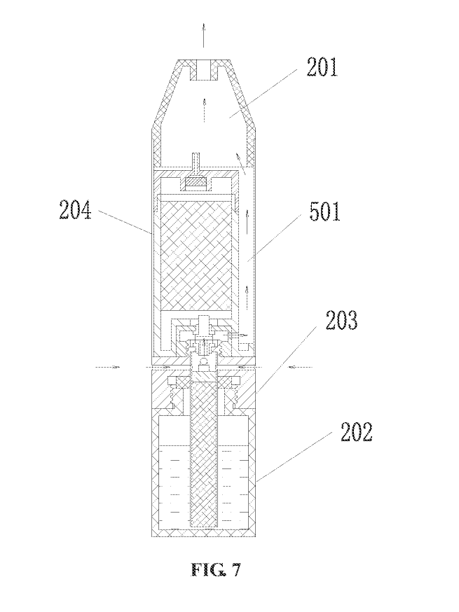

The suction end 201 is communicated with the air inlet by the fume passage 501, as shown in FIG. 7. FIG. 7 is a sectional structural view of an electronic cigarette in which the air inlet is provided on an outer wall of the atomizing assembly 203.

As shown in FIG. 7, the air inlet, which is arranged on an outer wall of the atomizing assembly 203, is communicated with the suction end 201 by the fume passage 501.

In this embodiment, airflow direction inside the electronic cigarette is presented by the arrow as shown in FIG. 7, the airflow direction does not pass through the liquid storage 202, so that the fumes atomized by the atomizing assembly 203 flow to the suction end 201 without passing through the liquid storage 202, thus the fumes do not condense due to the suction in the liquid storage 202 and do not block the fume passage 501, avoiding a condensation of the fumes and a block of fume passage as the fumes pass through the liquid storage area in the conventional technology.

Further, the battery rod assembly 204 in the disclosure can control the electric heating wire assembly 301 to atomize the liquid in the following two control modes.

One mode is shown in FIG. 5. In the battery sleeve 502, an airflow sensor 507 adapted to generate pulse signals is arranged close to the suction end 201;

The airflow sensor 507 will generate a pulse signal once detecting that the pressure in the fume passage 501 becomes less, i.e. while the user is sucking fumes.

In this embodiment, since the airflow sensor 507 is close to the position of the suction end 201, the sensitivity of the airflow sensor 507 in sensing the user action of sucking fumes is improved, thus the user can use the electronic cigarette more effectively.

A microcontroller adapted to generate control signals according to the pulse signals is connected with the airflow sensor 507 and the battery 503 separately. The microcontroller is further connected with the electric heating wire assembly 301, such that the electric heating wire assembly 301 can atomize the liquid according to the control signals.

The effect of cigarette smoking can be imitated by this arrangement, and the user can suck the atomized liquid from the suction end 201.

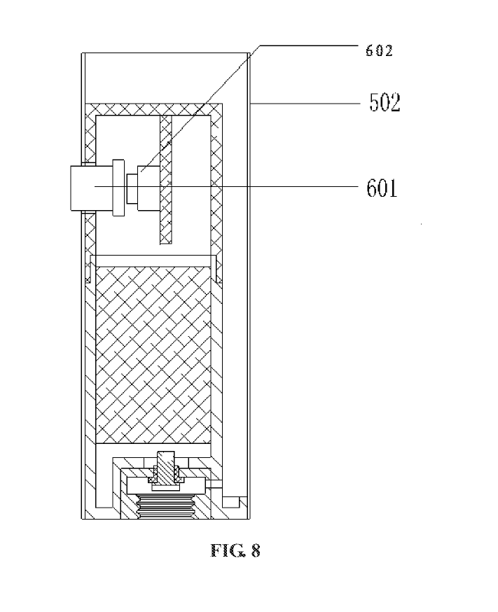

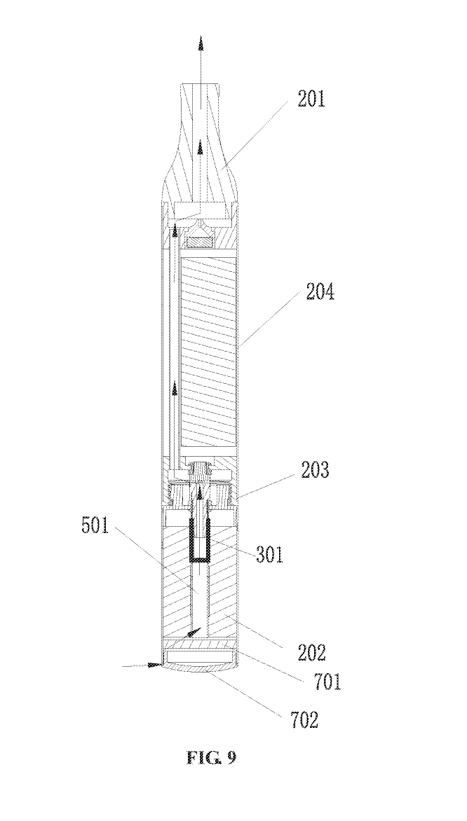

The second mode is shown in FIG. 8.

A button 601, adapted to receive user operation instructions, is arranged on the battery sleeve 502.

A light touch switch 602, adapted to generate control signals according to the operation instructions, is connected with the button 601.

The light touch switch 602 is further connected with the electric heating wire assembly 301, therefore the electric heating wire assembly 301 can atomize the liquid according to the control signal.

By this arrangement, the user does not need to suck the electronic cigarette through the suction end 201, and as long as the user presses the button 601, the electric heating wire assembly 301 of the electronic cigarette may atomize the liquid.

The electronic cigarette provided according to an embodiment of the disclosure may also imitate real smoking effect in terms of lighting, the detailed structure of which is shown in FIG. 9. The electronic cigarette in FIG. 9 includes:

a suction end 201 and a battery rod assembly 204. The detailed structures of the suction end 201 and the battery rod assembly 204 are described in above embodiments, and will not be detailed in this embodiment.

In this embodiment, the liquid storage 202 is integrated with the atomizing assembly 203, and the liquid storage 202 is arranged on an end of the body of the electronic cigarette away from the suction end 201.

Preferably, a fume passage 501 is arranged inside the liquid storage 202, an air inlet is arranged at the bottom of the liquid storage 202 to be communicated with the fume passage 501. The fume passage 501 extends to the suction end 201.

The airflow direction is presented by the direction of the arrow in FIG. 9. As shown in FIG. 9, compared to the above embodiments, the fume passage 501 in this embodiment is longer, and a longer fume passage 501 can reduce the temperature of the fumes atomized by the electric heating wire assembly 301, ensuring the user experience during smoking.

More preferably, a lamp module 701 may be further arranged at the bottom of the body of the electronic cigarette. When the user sucks fumes by the suction end 201, the lamp module 701 can emit lights which can imitate the effect of tobacco burning. The different lighting effect can be provided according to the requirement of the user.

An end cap 702 adapted to accommodate the lamp module 701 is arranged at the bottom of the body of the electronic cigarette, and the end cap 702 can be a transparent or non-transparent housing.

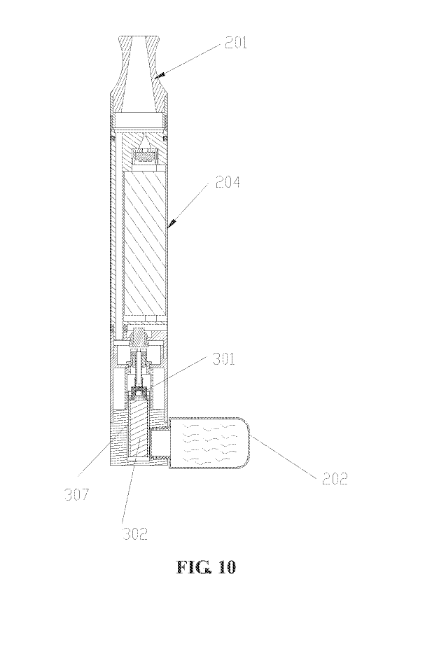

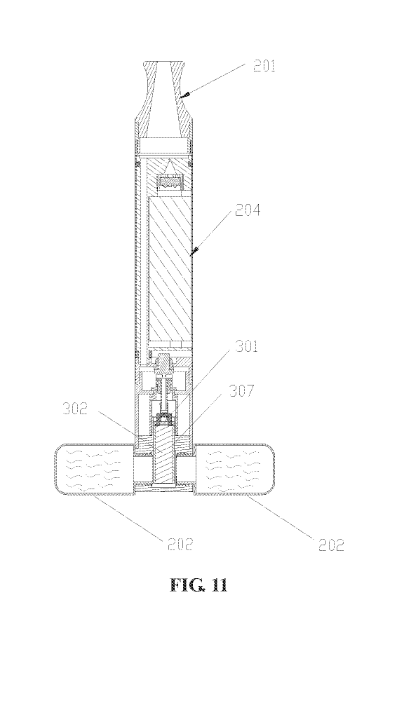

In order that the liquid inside the liquid storage can be conveyed to the liquid conveyer easier, another structure of the electronic cigarette is illustrated in detail in conjunction with an embodiment shown in FIG. 10 as follows.

As shown in FIG. 10, the electronic cigarette includes a suction end 201 and a battery rod assembly 204, where the detailed structures of the suction end 201 and the battery rod assembly 204 are described in above embodiments, and will not be detailed in this embodiment.

In this embodiment, the liquid storage 202 adapted to store the liquid is arranged on the outer circumferential wall of the atomizing assembly 203, hence the liquid in the liquid storage 202 can be conveyed to the liquid conveyer 302 inside the atomizing sleeve 307 through the liquid conveying hole arranged on the atomizing sleeve 307, and the electric heating wire assembly 301 atomize the liquid. The specific structure of the atomizing assembly 203 is described in above embodiments, and this embodiment is not limited in this aspect.

In this embodiment, the liquid flows in the liquid storage 202 along a direction perpendicular to or at an angle to the flow direction of liquid conveyed from the atomizing sleeve 307 to the electric heating wire assembly 301 for a atomization, avoiding convey of excessive liquid to the atomizer due to a shake for example, ensuring uniform liquid convey from the liquid storage 202 to the liquid conveyer 302 inside the atomizing sleeve 307 and guaranteeing stability of the fume amount. In addition, when the electronic cigarette drops and the bottom touches the ground, this structure can avoid the liquid storage 202 made of glass material from being broken due to a strike.

In this embodiment, the liquid storage 202 and the atomizing assembly 203 are in thread connection; other connection such as clamped connection may also be adopted and the specific connection is not limited in this embodiment.

In this embodiment, the number and the specific position of the liquid storage(s) 202 arranged on a side wall of the atomizing assembly 203 are not limited.

As shown in FIG. 10, in the case of one liquid storage 202 arranged on the side wall of the atomizing assembly, the body of the electronic cigarette is in a L-shape.

Alternatively, as shown in FIG. 11, in the case of two or more liquid storages 202 provided on the side wall of the atomizing assembly symmetrically, the body of the electronic cigarette is in a T-shape.

The technical solution according to the embodiments of the disclosure will be described clearly and fully in conjunction with the appended drawings. Apparently, the described embodiments are not the whole but just part of the embodiments of the present invention. All the other embodiments that can be gained by those with ordinary skills in the art without creative work shall fall into the scope of protection sought for in the present invention.

The embodiments of the present invention are described herein in a progressive manner, each of which emphasizes the differences from others; hence for the same or similar parts between the embodiments, one can refer to the other embodiments.

The above description of the disclosed embodiments enables those skilled in the art to implement or use the invention. Numerous modifications to the embodiments will be apparent to those skilled in the art, and the general principle herein can be implemented in other embodiments without departing from the spirit or scope of the invention. Therefore, the present invention shall not be limited to the embodiments described herein, but shall cover the widest scope consistent with the principle and novelty features disclosed herein.

1. An electronic cigarette comprising:
a body of the electronic cigarette; wherein
the body of the electronic cigarette comprises a suction end, a liquid storage adapted to store liquid, an atomizing assembly adapted to atomize the liquid, and a battery rod assembly adapted to supply power to the atomizing assembly; and
the liquid storage is arranged at an end of the body of the electronic cigarette away from the suction end.

2. The electronic cigarette according to claim 1, wherein the atomizing assembly is disposed between the battery rod assembly and the liquid storage, the suction end is disposed outside one end of the battery rod assembly, or the suction end is disposed at a middle portion of the battery rod assembly, or the suction end is disposed on a portion of the battery rod assembly away from the atomizing assembly.

3. The electronic cigarette according to claim 1, wherein the liquid storage is detachably connected with the atomizing assembly;
and/or,
the atomizing assembly is detachably connected with the battery rod assembly.

4. The electronic cigarette according to claim 1, wherein the atomizing assembly and the battery rod assembly are coaxially arranged.

5. The electronic cigarette according to claim 1, wherein the atomizing assembly comprises:
an electric hearing wire assembly adapted to atomize the liquid; and
a liquid conveyer adapted to convey the liquid stored in the liquid storage to the electric heating wire assembly for atomization.

6. The electronic cigarette according to claim 5, wherein the atomizing assembly further comprises:
an atomizer holder; wherein
a first thread sleeve adapted to be detachably connected with the battery rod assembly is arranged at a top of the atomizing holder; and
an atomizer electrode is fixedly arranged inside the first thread sleeve and is electrically connected with the electric heating wire assembly;
an insulating ring is arranged between the first thread sleeve and the atomizer electrode; and
an atomizing sleeve is arranged on the atomizer holder, and the liquid conveyer is arranged inside the atomizing sleeve.

7. The electronic cigarette according to claim 3, wherein a fume passage adapted to communicate the suction end with an air inlet is arranged inside the battery rod assembly;
the air inlet is arranged on a junction surface between the atomizing assembly and the liquid storage;
or,
the air inlet is arranged on an outer wall of the atomizing assembly.

8. The electronic cigarette according to claim 6, wherein the battery rod assembly comprises:
a battery sleeve;
a battery accommodated in the battery sleeve;
a battery holder adapted to fix the battery, wherein the battery holder is arranged in the battery sleeve;
a battery electrode arranged at one end of the battery holder and connected with the battery and the atomizer electrode; and
a second thread sleeve matching with the first thread sleeve to achieve a detachable connection between the battery rod assembly and the atomizing assembly.

9. The electronic cigarette according to claim 6, wherein a sealing ring adapted to seal the liquid storage is arranged at a joint between the atomizer holder and the liquid storage.

10. The electronic cigarette according to claim 6, wherein
an annular sealing plug with a through hole is arranged for matching with a mouth of the liquid storage in a sealed manner;
a piercable membrane adapted to seal the liquid storage is arranged in the through hole of the annular sealing plug.

11. The electronic cigarette according to claim 8, wherein the battery rod assembly further comprises:
an airflow sensor adapted to generate a pulse signal; and
a microcontroller adapted to generate a control signal according to the pulse signal, wherein the microcontroller is connected with the airflow sensor and the battery; and
the microcontroller is connected with the electric heating wire assembly, such that the electric heating wire assembly atomizes the liquid according to the control signal.

12. The electronic cigarette according to claim 8, wherein the battery rod assembly further comprises:
a button adapted to receive a user operation instruction, wherein the button is arranged on the battery sleeve; and
a light touch switch adapted to generate a control signal according to the operation instruction, wherein the light touch switch is connected with the button; and
the light touch switch is connected with the electric heating wire assembly, such that the electric heating wire assembly atomizes the liquid according to the control signal.

13. The electronic cigarette according to claim 8, wherein a suction nozzle as the suction end is detachably connected with the battery sleeve.

14. The electronic cigarette according to claim 1, wherein the liquid storage is a transparent container.

15. The electronic cigarette according to claim 14, wherein the liquid storage is a glass bottle.

16. The electronic cigarette according to claim 2, wherein the liquid storage is detachably connected with the atomizing assembly;
and/or,
the atomizing assembly is detachably connected with the battery rod assembly.

17. The electronic cigarette according to claim 2, wherein the atomizing assembly and the battery rod assembly are coaxially arranged.

18. The electronic cigarette according to claim 2, wherein the atomizing assembly comprises:
an electric hearing wire assembly adapted to atomize the liquid; and
a liquid conveyer adapted to convey the liquid stored in the liquid storage to the electric heating wire assembly for atomization.

19. The electronic cigarette according to claim 18, wherein the atomizing assembly further comprises:
an atomizer holder; wherein
a first thread sleeve adapted to be detachably connected with the battery rod assembly is arranged at a top of the atomizing holder; and
an atomizer electrode is fixedly arranged inside the first thread sleeve and is electrically connected with the electric heating wire assembly;
an insulating ring is arranged between the first thread sleeve and the atomizer electrode; and
an atomizing sleeve is arranged on the atomizer holder, and the liquid conveyer is arranged inside the atomizing sleeve.

20. The electronic cigarette according to claim 16, wherein a fume passage adapted to communicate the suction end with an air inlet is arranged inside the battery rod assembly;
the air inlet is arranged on a junction surface between the atomizing assembly and the liquid storage;
or,
the air inlet is arranged on an outer wall of the atomizing assembly.
